(19) United States
(12) Patent Application Publication
(10) Pub. No.: US 2025/0276820 A1
(43) Pub. Date: Sep. 4, 2025

(54) PACKAGING SYSTEM AND INFORMATION DISPLAY BODY ATTACHMENT METHOD

(71) Applicant: PACRAFT Co., Ltd., Tokyo (JP)

(72) Inventors: Noriyuki YAMANE, Yamaguchi-ken (JP); Yuka MIYANISHI, Yamaguchi-ken (JP)

(21) Appl. No.: 19/057,353

(22) Filed: Feb. 19, 2025

(30) Foreign Application Priority Data
Feb. 29, 2024 (JP) 2024-030733

(51) Int. Cl. B65B 57/00; B65B 43/50; G09F 7/00; G09F 7/18

(52) U.S. Cl. CPC B65B 57/005; B65B 43/50; G09F 7/00; G09F 2007/1873

(57) ABSTRACT

A packaging system that performs a packaging processing comprises an information display member including a metal portion in which information is visually displayed, wherein the information is displayed in the metal portion without shaving the metal portion.

### CROSS-REFERENCE TO RELATED APPLICATIONS

This application is based upon and claims the benefit of priority from Japanese Patent Application No. 2024-030733, filed on Feb. 29, 2024; the entire contents of which are incorporated herein by reference.

### TECHNICAL FIELD

The present disclosure relates to a packaging system and an information display body attachment method.

### BACKGROUND ART

Generally, a sticker is attached to a packaging system to alert an operator (see Japanese patent application publication No. 2014-201331).

### SUMMARY OF THE INVENTION

Stickers that are at least partially made of paper or resin are usually used as stickers attached to packaging systems. Stickers made of paper or resin are advantageous in that those types of stickers are relatively inexpensive and may easily receive various processing such as a printing processing and a surface processing, but are not necessarily durable and may relatively easily peel off from the packaging systems.

There is a concern that a sticker piece that peels off and is removed from a packaging system may unintentionally adhere to a container undergoing packaging processing in the packaging system, and with the sticker piece being adhered to the container, the container may receive the packaging processing and be sent to a subsequent stage. If a sticker piece adhered to a container is large, it is possible to remove such a container as a defective item through visual inspection, but if a sticker piece adhered to a container is small, it is difficult to find such a container through visual inspection. In particular, if a sticker piece adhering to a container is made of paper or resin, such a sticker piece cannot be detected even using a metal detector.

One of the objectives of the present disclosure is to provide a technology advantageous for hygienically displaying information on a packaging system.

An aspect of the present disclosure is directed to a packaging system that performs a packaging processing, comprising an information display member including a metal portion in which information is visually displayed, wherein the information is displayed in the metal portion without shaving the metal portion.

At least a part of the information may be displayed using a chromatic color.

The metal portion may be formed by a metal that undergoes at least one of a hot rolling treatment, a cold rolling treatment, a blasting treatment, a film formation treatment, and a vibrational polishing treatment.

The packaging system may comprise a lighting unit that illuminates the metal portion with light, wherein intensity of at least a part of a red wavelength range of the light may be greater than intensity of another visible light wavelength range of the light.

The information display member may be provided as a separate body from a structure associated with the packaging processing and is attached to the structure.

The information display member may be formed by a part of a structure associated with the packaging processing.

Another aspect of the present disclosure is directed to an information display body attachment method comprising a step of attaching an information display body to a packaging system, wherein the information display body includes a metal portion, information is visually displayed in the metal portion, and the information is displayed in the metal portion without shaving the metal portion.

According to the present disclosure, a technology advantageous for hygienically displaying information on a packaging system is provided.

### BRIEF DESCRIPTION OF DRAWINGS

FIG. 1 is a plan view showing a configuration example of a packaging system;

FIG. 2 is a side view of the packaging system shown in FIG. 1;

FIG. 3 is a front view illustrating an example of a packaging machine included in the packaging system shown in FIG. 1;

FIG. 4A is a diagram showing an example of information displayed on an information display member;

FIG. 4B is a diagram showing an example of information displayed on an information display member;

FIG. 4C is a diagram showing an example of information displayed on an information display member;

FIG. 4D is a diagram showing an example of information displayed on an information display member; and

FIG. 4E is a diagram showing an example of information displayed on an information display member.

### DETAILED DESCRIPTION

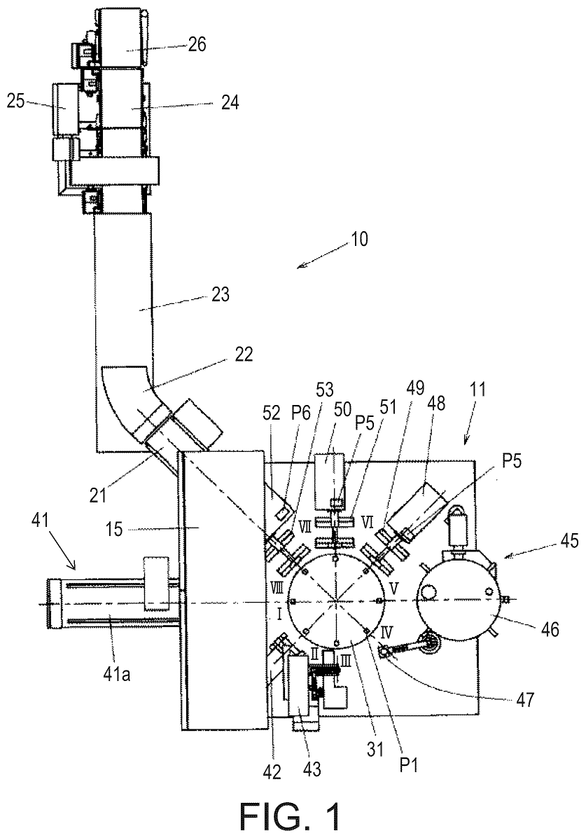

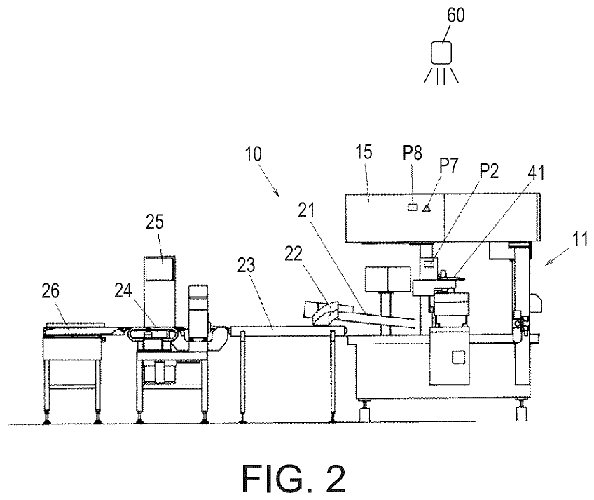

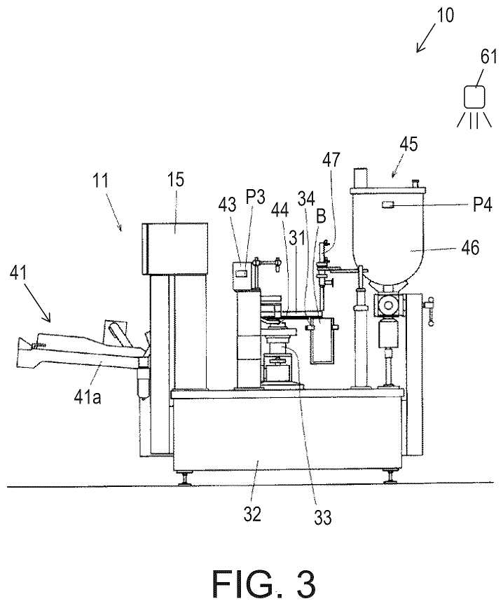

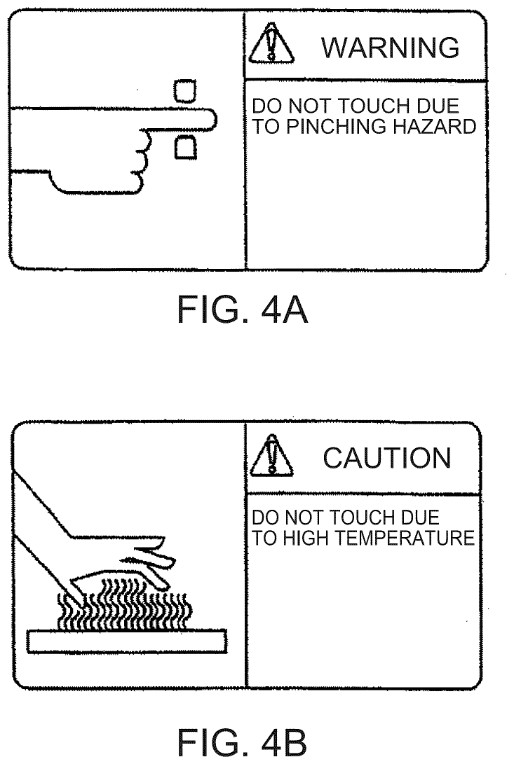

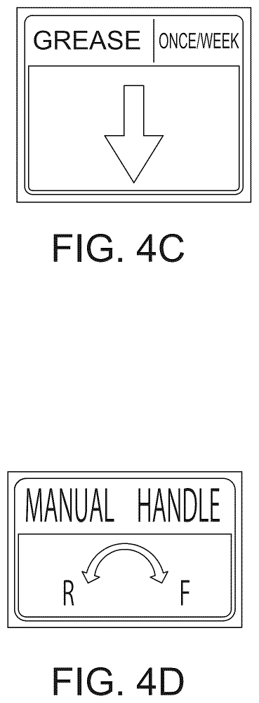

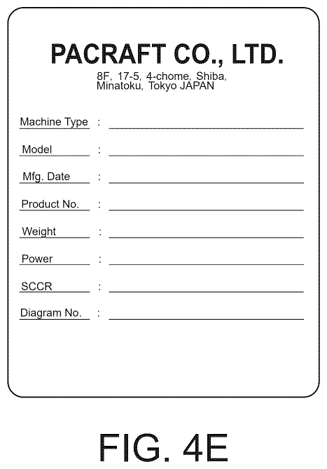

FIG. 1 is a plan view showing a configuration example of a packaging system 10. FIG. 2 is a side view of the packaging system 10 shown in FIG. 1. FIG. 3 is a front view illustrating an example of a packaging machine 11 included in the packaging system 10 shown in FIG. 1. FIGS. 4A to 4E are diagrams showing examples of information displayed in an information display member.

The packaging system 10 shown in FIGS. 1 to 3 is configured as a bagging-packaging system that performs packaging processing using bags (containers) B, and comprises a rotary bagging-packaging machine 11 with an intermittent rotary style (hereinafter referred to simply as a “packaging machine 11”) that introduces contents into a bag B under control of a packaging control device 15.

The packaging system 10 in the present example comprises, in addition to the packaging machine 11, a discharge conveyor 21 that conveys bags (product bags) B discharged from the packaging machine 11; a discharge chute 22 that discharges bags (product bags) B discharged by the discharge conveyor 21, onto a transfer conveyor 23; a metal detector 24 positioned along the transfer conveyor 23; a determination control device 25 that determines whether bags (product bags) B are good or not good based on the detection signals (detection results) sent from the metal detector 24; and a defective product elimination conveyor 26 that sends bags B determined to be good to a subsequent stage while removing bags B determined to be not good based on the determination results by the determination control device 25.

The packaging machine 11 comprises a rotary table 31. Rotary table 31 is fixed to the upper end of a rotary shaft (not shown in the drawings) that is driven to rotate intermittently by a driving source such as a motor, and is driven to rotate intermittently along with the rotary shaft. The rotary shaft attached to the rotary table 31 in the present example extends to penetrate through the inside of a stand 33 erected on a machine stand 32, as shown in FIG. 3. On the periphery of the rotary table 31, a plurality of gripper pairs 34 (in the present example, eight gripper pairs 34) are mounted at equal intervals in the circumferential direction. Each gripper pair 34 has two grippers for gripping the left and right lateral portions of a bag B. In FIG. 3, a gripper pair 34 that is intermittently positioned at a liquid injection station IV is shown together with a bag B.

Information display plates (i.e., information display members) P1 are fixedly attached to the top surface of the rotary table 31 at positions corresponding to a plurality gripper pairs 34 (8 gripper pairs 34) (see FIG. 1), and on each of the Information display plates P1, the identification number (identification information) of a corresponding gripper pair 34 is visually displayed. As shown in FIG. 3, the bag mouth of a bag B held by a gripper pair 34 is located below the lower surface of the rotary table 31.

As the rotary table 31 rotates intermittently, each gripper pair 34 moves to a plurality of processing stations I-VIII in sequence and circulates through the plurality of processing stations I-VIII (see FIG. 1).

In a bag supplying station I, a bag supplying process is performed and a bag supplying device 41 supplies a bag (in the present example, an empty bag) B to a gripper pair 34 that is intermittently stopped at the bag supplying station I. The bag supplying device 41 in the present example is a magazine-type bag supplying device equipped with a magazine 41a, and a lot of bags (empty bags) B are stored in the magazine 41a. A bag B that is positioned at the head position in the magazine 41a is lifted one by one and passed to a gripper pair 34 by a pick-up device.

An information display plate (i.e., an information display member) on which information related to the bag supplying device 41 is visually displayed is attached to the bag supplying device 41 in the present example (see FIG. 2). The information displayed on this information display plate P2 is not limited. For example, in a case where the pick-up device of the bag supplying device 41 lifts a bag B using a suction cup, a vacuum pressure sensor may be provided to detect the pressure (vacuum pressure) at the suction surface of the suction cup and determine whether the suction cup is vacuuming a bag B under normal conditions. In this case, information on adjusting the setting value of the vacuum pressure sensor or the suction cup, etc., may be displayed on the information display plate P2.

Also, the indication on the information display plate P2 may be compliant with the Product Liability Law (PL Law), and for example, alert information to alert users to risks such as being caught in a pinch may be displayed on the information display plate P2.

The printing process is performed at a printing station II and a printing device 42 prints various information, such as the date of manufacture, on a bag B supported by a gripper pair 34 that is intermittently stopped at the printing station II.

An opening process is performed at an opening station III and a pair of suction cups 44 (see FIG. 3) included in an opening device 43 performs an opening motion such that the pair of suction cups 44 opens the mouth portion formed by the top end portion of a bag B while vacuuming and suctioning both sides of the bag B supported by a gripper pair 34 that is intermittently stopped at the opening station III. An information display plate (i.e., an information display member) P3 on which information related to the opening device 43 is visually displayed is attached to the opening device 43 in the present example (see FIG. 3). The information displayed on this information display plate P3 is not limited. For example, a vacuum pressure sensor may be provided to detect the pressure (vacuum pressure) in the suction surface of the suction cups 44 of the opening device 43 and determine whether the suction cups 44 are vacuuming a bag B under normal conditions. In this case, information on adjusting the setting value of the vacuum pressure sensor or the cups, etc., may be displayed on the information display plate P3.

Also, the indication on the information display plate P3 may be compliant with the PL Law, and for example, alert information to alert users to risks may be displayed on the information display plate P3.

The liquid injection process is performed at a liquid injection station IV and a liquid injecting device 45 injects liquid contents into the inside of a bag B through the mouth portion (in an open state) of the bag B that is supported by a gripper pair 34 that is intermittently stopped at the liquid injection station IV. The liquid injecting device 45 in the present example includes: a tank 46 that stores the liquid contents; and a nozzle 47 that ejects the liquid contents sent from the tank 46, and the liquid contents ejected from the nozzle 47 are injected into a bag B. An information display plate (i.e., an information display member) P4 on which information related to the tank 46 is visually displayed is attached to the tank 46 in the present example (see FIG. 3). The information displayed on this information display plate P4 is not limited. For example, precautions for cleaning the tank 46 may be displayed on the information display plate P4.

A press degassing process is performed at a degassing station V and a pair of pressure plates (not shown in the drawings) of a press degassing device contacts and pressurizes both side surfaces of a bag B supported by a gripper pair 34 that is intermittently stopped at the degassing station V in such a manner that gas is expelled from the bag B. An information display plate (i.e., an information display member; not shown in the drawings) on which information related to the press degassing device is visually displayed may be attached to the press degassing device in the present example, and for example, an information display plate on which warning information (alert information) as shown in FIG. 4A may be attached to the press degassing device.

A first sealing process is performed at a first sealing station VI and a pair of heat plates 49 of a first sealing device 48 pinches and pressurizes the mouth portion of a bag B that is supported by a gripper pair 34 that is intermittently stopped at the first sealing station VI in such a manner that the mouth portion is heated and sealed. A second sealing process is performed at a second sealing station VII and a pair of heat plates 51 of a second sealing device 50 pinches and pressurizes the mouth portion of a bag B that is supported by a gripper pair 34 that is intermittently stopped at the second sealing station VII in such a manner that the mouth portion is heated and sealed. Information display plates (i.e., information display members) P5 on which information related to the first sealing device 48 and the second sealing device 50 is visually displayed are attached to the first sealing device 48 and the second sealing device 50 in the present example (see FIG. 1). For example, information display plates P5 on which warning information (alert information) as shown in FIG. 4A and/or FIG. 4b is displayed may be attached to the first sealing device 48 and the second sealing device 50.

A cooling-sealing process and a product bag releasing process are performed at a cooling-releasing station VIII. Specifically, a pair of cooling plates 53 of a cooling device 52 pinches and pressurizes the mouth portion of a bag B supported by a gripper pair 34 that is intermittently stopped at the cooling-release station VIII in such a manner that the mouth portion (in particular, the part that has undergone the heat sealing processes) is cooled to stabilize the seal state. After this cooling-sealing processing is performed, the pair of cooling plates 53 is placed in an open state and the gripper pair 34 is placed in an open state, so that the bag (product bag) B is released from the gripper pair 34 that is intermittently stopped at the cooling-release station VIII, and drops onto the discharge conveyor 21. An information display plate (i.e., an information display member) P6 on which information related to the cooling device 52 is visually displayed is attached to the cooling device 52 (see FIG. 1). For example, an information display plate P6 on which warning information (alert information) as shown in FIG. 4A is displayed may be attached to the cooling device 52.

A bag dropped on the discharge conveyor 21 is passed from the discharge conveyor 21 to the discharge chute 22 and from the discharge chute 22 to the transfer conveyor 23, and a detection of metal in the bag B is performed by the metal detector 24 in the middle of the conveyance of the bag by the transfer conveyor 23.

As shown in FIG. 2, two information display plates P7, P8 are attached to the packaging control device 15 in the present example. One information display plate P7 has a triangular shape and displays an illustration of electricity (e.g., a symbol representing lightning), indicating that electricity may flow at the mounting section. The other information display plate P8 has a rectangular shape and visually displays information related to the packaging control device 15, and for example, may show information about work by an operator.

### [Information Display Members]

In the packaging system 10 shown in FIGS. 1 to 3 as described above, the information display plates (information display members) P1 to P8 displaying various types of information, are attached to corresponding structures associated with the packaging processing, respectively. In particular, each of the information display plates P1 to P8 of the present embodiment includes a metal portion, and various information is visually displayed on the metal portion, and in particular, the various information is displayed on the metal portion without shaving the metal portion of the information display member.

Each of the information display plates P1 to P8 may be entirely formed by metal or partially formed by metal. From the viewpoint of achieving good durability in the information display plates P1 to P8, each of the information display plates P1 to P8 may be entirely composed of metal, or may be composed of a combination of a metal portion and another material that is more durable than the metal portion. However, considering that dirt can easily accumulate and bacteria can grow between adjacent members, each of the information display plates P1 to P8 may be entirely composed of a single composition metal having an integral structure.

The metal portions used in the information display plates (information display members) P1 to P8 can be made of any metallic material, but are made of metals that remain a solid state under operating conditions (e.g., at room temperature and ordinary pressure), and may be made of stainless steel, titanium or aluminum.

The metal portions used in the information display plates (information display members) P1 to P8 can be made by any manufacturing method and can undergo any treatment. For example, metals that have undergone at least one of the following treatments may be used as the metal portions of the information display members: a hot rolling treatment (a hot plate treatment), a cold rolling treatment (a cold plate treatment), a blasting treatment (e.g., a sandblasting or a bead blasting treatment), a film formation treatment (e.g., an oxide film formation treatment), and a vibrational polishing treatment.

For example, when the information display plates P1 to P8 (in particular, the surface parts) are formed by aluminum, an alumite treatment (an oxide film formation treatment) may be applied, as a film formation treatment, to the information display plates P1 to P8. In this case, the surfaces of the information display plates P1 to P8 can be protected by alumite, which has excellent corrosion resistance and friction resistance, and various colors can be given to the surfaces of the information display plates P1 to P8 using the excellent coloring property of the alumite. The method of performing such an alumite treatment can, for example, apply masking to the information display plates P1 to P8 and applying an alumite treatment to the information display plates P1 to P8 multiple times, so that the information display plates P1 to P8 can be colored in a desired color. The laser marking processing applied to the information display plates P1 to P8 may be performed before or after an alumite treatment.

In cases where the metal portions of the information display plates P1 to P8 are dug (scraped) by a laser or other means, it is assumed that rust may occur and therefore, if necessary, a rust-proof treatment (e.g., a chemical conversion coating treatment that forms a protective film (a film of insoluble compound) on the metal surface) may be applied to the information display plates P1 to P8. For example, in cases where a laser marking processing is performed using a laser such as a fiber laser in which the depth to be dug into the metal portion can be set appropriately, such a rust-proof treatment may be performed according to the depth to be dug (according to the irradiation intensity of the laser).

The information displayed on the information display plates (information display members) P1 to P8 may be displayed using any one or more colors, may be displayed using only achromatic colors (white and/or black), and may be displayed using chromatic colors partially or entirely.

In the present example, laser irradiation is used in the treatment method for displaying various information on the metal portions of the information display plates P1 to P8, but the treatment method is not limited to this, and various information can be displayed on the metal portions in any way.

The information displayed on the metal portions of the information display plates P1 to P8 in the present example is displayed on the metal portions without shaving the metal portions as described above. For example, various information may be displayed in a desired color(s) (an achromatic color(s) and/or a chromatic color(s)) by using a chemical reaction (a color change reaction/a tarnishing reaction) of the metal portion of the information display plates P1 to P8 or by forming an oxide film on a metal portion and using interference between the light reflected on the metal portion and the light reflected on the oxide film. The oxide film formed on the surface of a metal portion may be a separate component from the metal portion and may be generated by, for example, irradiating the surface of the metal portion with a laser.

Methods of displaying information on metal by using a laser are publicly known technology, and for example, laser marker technology is widely used to mark information on metal by altering properties of the surface state of the metal by laser irradiation. Various methods based on various principles are known as laser marker technology, and laser marker technology using any method can be applied to the marking of desired information on the metal portions of the information display plates P1 to P8 described above.

The specific content of information displayed on the information display plates (information display members) P1 to P8 is not limited, and any information can be displayed on the information display plates P1 to P8. Typically, warnings that alert or inform operators of risks (e.g., warnings compliant with PL laws), the name of the corresponding structure or other information (e.g., characteristics, date of manufacture, etc.) may be displayed on the information display plates P1-P8. For example, the information display plate shown in FIG. 4A displays a warning that there is a risk of a finger or other objects being caught and pinched in a target device. Further, the information display plate shown in FIG. 4B displays a warning that there is a risk of contact of a hand or other objects with a hot exposed part of a target device. Further, the information display plate shown in FIG. 4C displays information informing users of an interval (i.e., once a week) of applying grease to a target device. Further, the information display plate shown in FIG. 4D displays information informing users of a correspondence between the direction of rotation of a manual handle (MANUAL HANDLE) and the drive direction of a corresponding device (R: backward drive; F: forward drive). Further, the information display plate shown in FIG. 4E displays indications informing users of various information about the device (i.e., the machine type, the model name, the date of manufacture, the product number, the weight, the output power, the short-circuit current rating (SCCR), and the drawing number).

Further, the form of information on the information display plates P1 to P8 is not limited, and information with desired contents can be displayed on the information display plates P1 to P8 by means of letters and/or diagrams (e.g., logos, icons, marks (e.g., a mark of a push button switch), pictograms, and other displays other than characters).

The packaging system 10 of the present embodiment further comprises lighting devices 60, 61 that irradiate metal portions of the information display plates (information display members) P1 to P8 with light, as shown in FIGS. 2 and 3, although the lighting devices 60, 61 are omitted and not shown in FIG. 1. The lighting devices 60, 61 may comprise LEDs (Light-Emitting Diodes), for example, and may irradiate with light the entirety of the structures to which the information display plates P1 to P8 to be irradiated are attached, or may intensively (locally) irradiate the information display plates P1 to P8 to be irradiated with strong light having directional characteristics.

The lighting devices 60, 61 emit light in any visible light wavelength range (e.g., 360 nm to 830 nm) that is effective in improving the visibility of information displayed on the information display plates P1 to P8, but the specific wavelength characteristics (spectral characteristics) of such illumination light are not limited. For example, information with a greater degree of alertness is more likely to be displayed by red color. In view of this fact, the intensity of at least a part of the red wavelength range (e.g., 625 nm to 780 nm) of the light radiated to the metal portions of the information display plates P1 to P8 by the lighting devices 60, 61 may be greater than the intensity of the other visible light wavelength range of the light.

As explained above, according to a packaging system, an information display member (information display plates P1 to P8), an information display body attachment method (a method of attaching an information display plate to a structure associated with the packaging processing), and a packaging system manufacturing method (a structure manufacturing method), information is displayed on a metal portion, which makes it possible to hygienically display information on the packaging system in a form that is excellent in durability. In particular, in cases where each information display plate (including a metal portion) is made of a material having an excellent corrosion-resistant property, each information display plate can be used for a long period of time.

Further, in cases where each information display plate is made entirely of metal or of a metal and a material stronger than the metal, there is almost no risk of the occurrence of breakage of each information display plate and therefore there is almost no concern of mixing of a breakage piece of each information display plate with contents in a bag B.

The method of attaching such an information display plate to a corresponding structure is not limited, and each information display plate may be attached to a corresponding structure via a screw or other fixing devices with excellent fixing strength. In this case, each information display plate can be effectively prevented from unintentionally falling off a corresponding structure.

Further, since each information display plate includes a metal portion, even if a part of or the entirety of the metal portion should fall off a corresponding structure, the metal piece that has fallen off can be detected by the metal detector 24 installed downstream and can be removed based on the results of the detection.

Further, in cases where a metal portion itself of each information display plate or the indication of the information displayed on the metal portion is excellent in durability (e.g., friction resistance) and water resistant, it is possible to keep each information display plate clean by rubbing the metal portion with a cloth or another material or by spraying the metal portion with cleaning water such as water. In particular, in cases where a metal portion itself of each information display plate or the indication of the information displayed on the metal portion is excellent in heat resistant, the metal portion can be washed at high temperatures by spraying the metal portion with hot cleaning water.

Further, since information is displayed on a metal portion of each information display plate without shaving the metal portion, it is possible to effectively suppress the formation of a large depth recess in the metal portion. Generally, the greater the depth of a recess, the more difficult it becomes to clean the recess, and the more likely it is for bacteria to grow in the recess. On the other hand, according to each information display plate of the present embodiment described above, the metal portion can be cleaned relatively easily and the growth of bacteria can be effectively suppressed.

As described above, each information display plate of the present embodiment can achieve excellent characteristics with respect to both safety and hygiene.

Further, in cases where information is displayed on a metal portion of an information display plate with a chromatic color(s), it is possible to display a variety of information in a variety of forms with good visibility, alerting operators effectively and thus improving safety.

### [Variant Examples]

In the embodiments described above, the information display plates (information display bodies) P1 to P8 that are provided as separate bodies from corresponding structures associated with the packaging processing and are provided to be attachable to such corresponding structures, are used as information display members, but such information display members may be configured by structures associated with the packaging processing. Specifically, various information may be displayed directly on a metal portion forming a part of each of structures associated with the packaging processing (e.g., the rotary table 31, the bag supplying device 41, the opening device 43, the liquid injecting device 45 (the tank 46), the first sealing device 48, the second sealing device 50, the cooling device 52, and/or the packaging control device 15), without shaving the metal portion. The information display member may be formed by a part of a structure associated with the packaging processing.

Further, although the packaging processing in the above embodiment uses bags B, any container other than bags B may be used in the packaging processing. The packaging system 10 may perform any other processing related to packaging in addition to the above processes or instead of at least one of the above processes.

It should be noted that the embodiments and variant examples disclosed in the present specification are in all respects illustrative only and are not to be construed as limiting. Therefore, elements that are equivalent or alternative to the elements shown as an example in the above-described embodiments and variant examples fall under the disclosed scope of the present specification, and the specification including the claims should be construed based not only on the above-described elements shown as an example but also on equivalent elements and alternative elements to the above-described elements. An element(s) of the above-described embodiments and variant examples may be omitted, replaced or changed to another element in various forms without departing the appended claims and their gist. For example, the embodiments and variant examples described above may be combined in whole or in part, and embodiments other than those described above may be combined with the embodiments or variant examples described above. Further, the effects of the present disclosure described in the present specification are illustrative only, and other effects may be brought about.

The technical categories that embody the technical ideas described above are not limited. For example, the above-described technical ideas may be embodied by a computer program for having a computer execute one or more procedures (steps) included in a method of manufacturing or using the device described above. Further, the above-described technical ideas may be embodied by a computer-readable non-transitory recording medium in which such a computer program is recorded.

### [Additional Notes]

The disclosed technology may also take the following aspects.

### [Aspect 1]

A packaging system that performs a packaging processing, comprising an information display member including a metal portion in which information is visually displayed,
wherein the information is displayed in the metal portion without shaving the metal portion.

### [Aspect 2]

The packaging system as defined in aspect 1, wherein at least a part of the information is displayed using a chromatic color.

### [Aspect 3]

The packaging system as defined in aspect 1 or 2, wherein the metal portion is formed by a metal that undergoes at least one of a hot rolling treatment, a cold rolling treatment, a blasting treatment, a film formation treatment, and a vibrational polishing treatment.

### [Aspect 4]

The packaging system as defined in one of aspects 1 to 3, comprising a lighting unit that illuminates the metal portion with light, wherein intensity of at least a part of a red wavelength range of the light is greater than intensity of another visible light wavelength range of the light.

### [Aspect 5]

The packaging system as defined in one of aspects 1 to 4, wherein the information display member is provided as a separate body from a structure associated with the packaging processing and is attached to the structure.

### [Aspect 6]

The packaging system as defined in one of aspects 1 to 4, wherein the information display member is formed by a part of a structure associated with the packaging processing.

### [Aspect 7]

An information display body attachment method comprising a step of attaching an information display body to a packaging system,
wherein the information display body includes a metal portion, information is visually displayed in the metal portion, and the information is displayed in the metal portion without shaving the metal portion.

1. A packaging system that performs a packaging processing, comprising an information display member including a metal portion in which information is visually displayed,
wherein the information is displayed in the metal portion without shaving the metal portion.

2. The packaging system as defined in claim 1, wherein at least a part of the information is displayed using a chromatic color.

3. The packaging system as defined in claim 1, wherein the metal portion is formed by a metal that undergoes at least one of a hot rolling treatment, a cold rolling treatment, a blasting treatment, a film formation treatment, and a vibrational polishing treatment.

4. The packaging system as defined in claim 1, comprising a lighting unit that illuminates the metal portion with light,
wherein intensity of at least a part of a red wavelength range of the light is greater than intensity of another visible light wavelength range of the light.

5. The packaging system as defined in claim 1, wherein the information display member is provided as a separate body from a structure associated with the packaging processing and is attached to the structure.

6. The packaging system as defined in claim 1, wherein the information display member is formed by a part of a structure associated with the packaging processing.

7. An information display body attachment method comprising a step of attaching an information display body to a packaging system,
wherein the information display body includes a metal portion, information is visually displayed in the metal portion, and the information is displayed in the metal portion without shaving the metal portion.
